(19) United States
(12) Patent Application Publication
(10) Pub. No.: US 2012/0008110 A1
(43) Pub. Date: Jan. 12, 2012

(54) PROJECTOR MODULE WITH ENGAGEMENT DESIGN AND RELATED COMBINATIVE PROJECTOR MODULE

(76) Inventors: Wei-Chieh Chen, Taoyuan County (TW); Yung-Yu Chiang, New Taipei City (TW)

(21) Appl. No.: 13/175,968

(22) Filed: Jul. 5, 2011

(30) Foreign Application Priority Data
Jul. 6, 2010 (TW) 099122138

(51) Int. Cl. G03B 21/14

(52) U.S. Cl. 353/119

(57) ABSTRACT

A projector module includes a projector and an electronic device. The projector includes a projector case, a first connector, and at least one guide rail structure. The first connector and the guide rail structure are disposed on the projector case. The projector is detachably disposed on the electronic device. The electronic device includes a device case, a second connector, and at least one protruding structure. The second connector and the protruding structure are disposed on the device case. The second connector is used for electrically connecting to the first connector so as to establish transmission between the projector and the electronic device. When the projector case slides laterally relative to the device case to make the first connector electrically connected to the second connector, the protruding structure is engaged with the guide rail structure so as to fix the projector onto the electronic device.

### BACKGROUND OF THE INVENTION

1. Field of the Invention

The present invention relates to a projector module and a related combinative projector module, and more specifically, to a projector module with an engagement design and a related combinative projector module.

2. Description of the Prior Art

With development of electronic technology and optical technique, a projector is wildly used in daily life. For example, reports or charts can be projected on a display screen by a projector for people attending the conference to view information offered by the report together, or a user can utilizes a projector to project video images to enjoy a movie-like audio-visual experience at home.

In general, if a projector needs to be electrically connected to an electronic device, such as electrically connecting to a video playback device (e.g. a DVD (Digital Versatile Disk) player) for performing video data transmission or electrically connecting to an external power source (e.g. a 110V power source in a common residence) for performing power transmission, a conventional design is to utilize a cable for establishing electrical connection of the projector and the electronic device. However, since this method is limited in operation by the length of the cable, it not only causes a user much inconvenience in using the projector, but also limits portability of the projector. Although the projector can be installed on the electronic device by a device integration design for solving the said problems, the said device integration design may also cause a problem that the structural design of the projector is too complicated.

### SUMMARY OF THE INVENTION

The present invention provides a projector module with an engagement design. The projector module includes a projector and an electronic device. The projector includes a projector case, a first connector, and at least one guide rail structure. The first connector is disposed on the projector case. The guide rail structure is disposed on the projector case. The electronic device is detachably disposed on the projector. The electronic device includes a device case, a second connector, and at least one protruding structure. The second connector is disposed on the device case for electrically connecting to the first connector so as to establish transmission between the projector and the electronic device. The protruding structure is disposed on the device case for engaging with the guide rail structure so as to fix the projector onto the electronic device when the projector case slides laterally relative to the device case to make the first connector electrically connected to the second connector.

The present invention further provides a combinative projector module includes a projector and a plurality of electronic devices. The projector includes a projector case and a first connector. The first connector is disposed on the projector case. The plurality of electronic devices is detachably disposed on the projector. Each electronic device includes a device case, a second connector, and a third connector. The second connector is disposed on the device case for electrically connecting to the first connector to establish transmission between the projector and the electronic device. The third connector is disposed on the device case for electrically connected to the second connector on another electronic device to establish transmission between the two electronic devices.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is an assembly diagram of a projector module according to a first embodiment of the present invention.

FIG. 2 is a diagram of a projector in FIG. 1.

FIG. 3 is a diagram of an electronic device in FIG. 1.

FIG. 4 is a bottom view of the electronic device in FIG. 3.

FIG. 5 is an assembly diagram of a combinative projector module 100 according to a second embodiment of the present invention.

FIG. 6 is a diagram of a projector in FIG. 5.

FIG. 7 is a diagram of an electronic device in FIG. 5.

FIG. 8 is a bottom view of the electronic device in FIG. 7.

### DETAILED DESCRIPTION

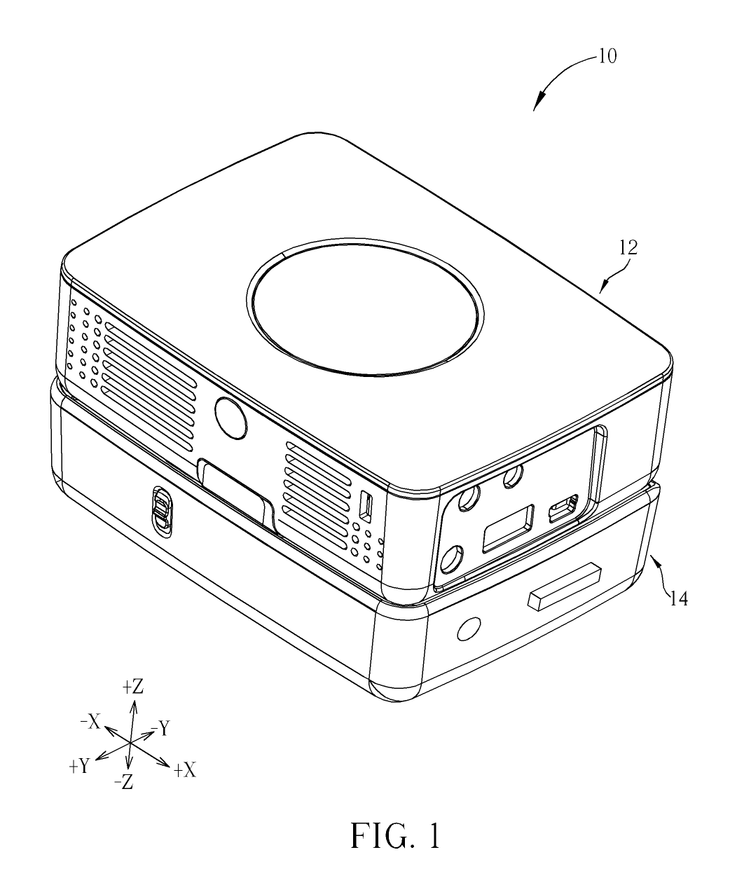

Please refer to FIG. 1, which is an assembly diagram of a projector module 10 according to a first embodiment of the present invention. As shown in FIG. 1, the projector module 10 includes a projector 12 and an electronic device 14. In the present invention, the projector 12 is detachably disposed on the electronic device 14. In the following, the structural designs of the projector 12 and the electronic device 14 are described in detail respectively.

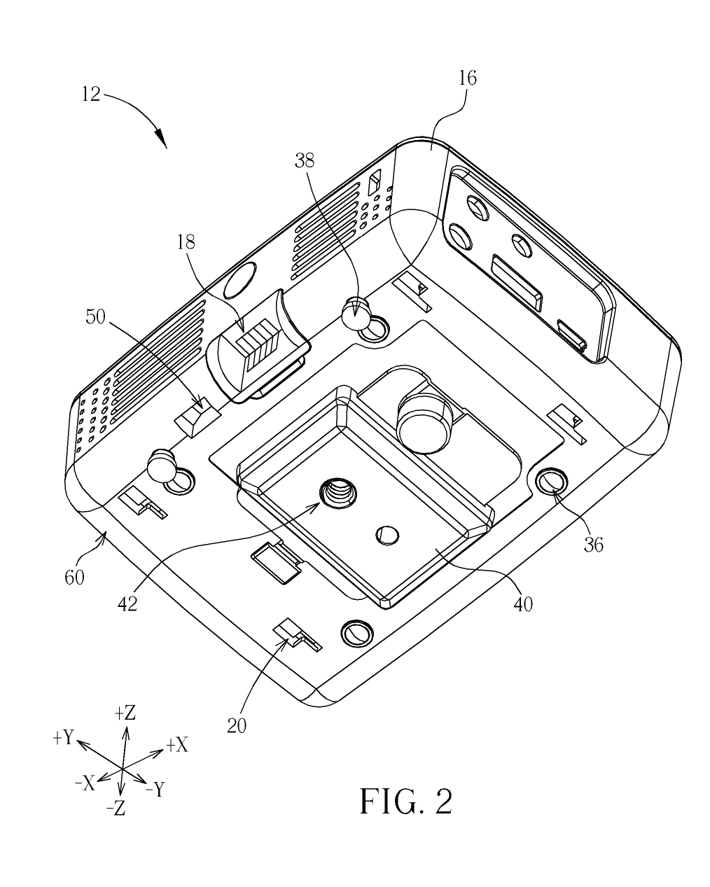

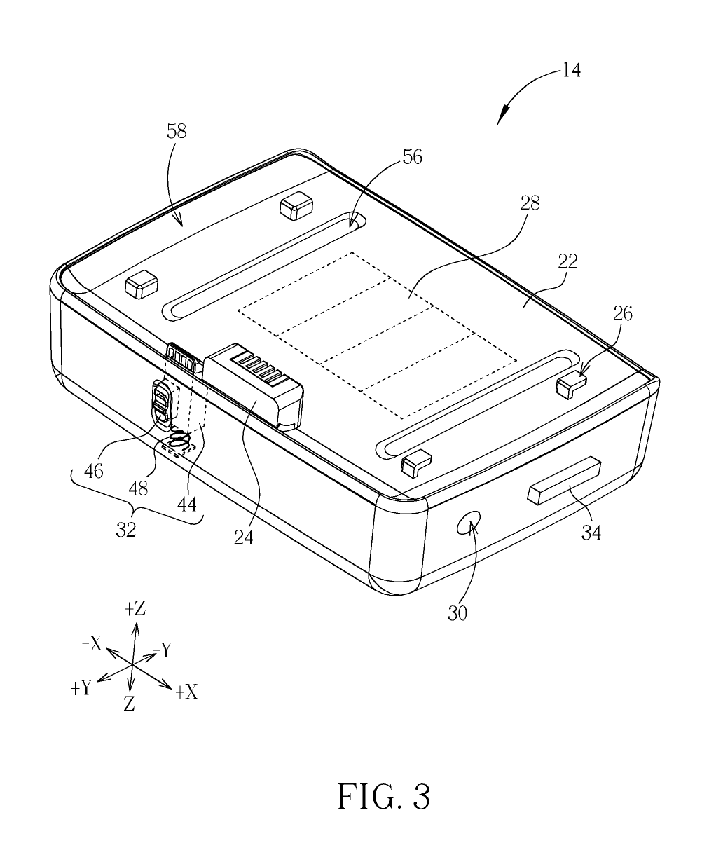

Please refer to FIG. 2 and FIG. 3. FIG. 2 is a diagram of the projector 12 in FIG. 1. FIG. 3 is a diagram of the electronic device 14 in FIG. 1. As shown in FIG. 2 and FIG. 3, the projector 12 includes a projector case 16, a first connector 18, and at least one guide rail structure 20 (four shown in FIG. 2). The electronic device 14 includes a device case 22, a second connector 24, at least one protruding structure 26 (four shown in FIG. 3), a battery 28, a plug 30, a locking mechanism 32, and a button mechanism 34.

First, the structural design of the projector 12 is described as follows. The first connector 18 is disposed on the projector case 16. The first connector 18 is used for electrically connecting to the second connector 24 to establish power transmission between the projector 12 and the electronic device 14. The guide rail structure 20 is disposed on the projector case 16. The guide rail structure 20 is used for engaging with the protruding structure 26 so as to fix the projector 12 onto the electronic device 14 when the projector case 16 slides laterally relative to the device case 22 (i.e. a +Y-axis direction shown in FIG. 3) to make the second connector 24 electrically connected to the first connector 18.

Furthermore, the projector 12 further includes at least one pad 36 (four shown in FIG. 2), at least one support foot 38 (two shown in FIG. 2), and a docking station 40. The pad 36 is disposed on the projector case 16 for providing friction force to the projector case 16 so that the projector 12 can be disposed on a holding surface steadily. The support foot 30 is telescopically disposed on the projector case 16. The support foot 38 is used for adjusting an inclined angle of the projector case 16 so as to achieve the purpose that the projection angle of the projector 12 can be adjustable. The docking station 40 is detachably disposed on the projector case 16. When the docking station 40 is installed on the projector case 16, the projector case 16 can be screwed onto a support frame via a fixing hole 42 formed on the docking station 40.

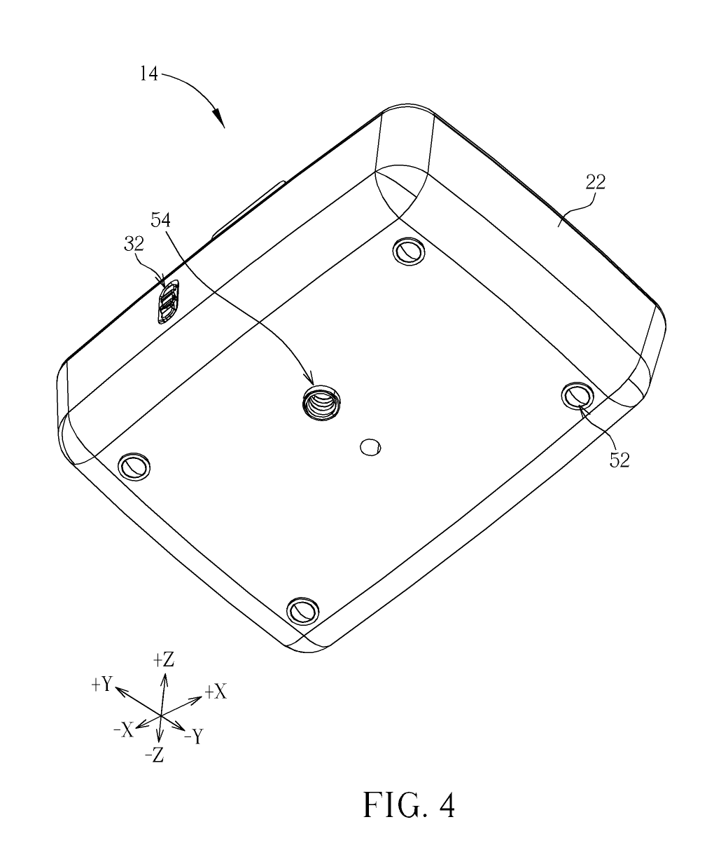

In the following, description for the structural design of the electronic device 14 is provided. The second connector 24 and the protruding structure 26 are disposed on the device case 22. The battery 28 is disposed in the device case 22 and electrically connected to the second connector 24. The battery 28 is used for providing electrical power to the projector 12. The plug 30 is disposed on the device case 22 and electrically connected to the battery 28. The plug 30 is used for connecting to an external power source to recharge the battery 28. In other words, in this embodiment, the electronic device 14 can be a power supply device for transmitting electrical power to the projector 12. The locking mechanism 32 is disposed on the device case 22 for engaging with the projector case 16. The locking mechanism 32 includes an engaging member 44, an operating member 46, and a spring 48. The engaging member 44 is movably disposed on the device case 22 and is connected to the operating member 46. The operating member 46 is used for driving the engaging member 44 to make the engaging member 44 engaged with or separate from a positioning hole 50 of the projector case 16 as shown in FIG. 2. The spring 48 is connected to the engaging member 44 for providing elastic force to drive the engaging member 44 to be engaged with the positioning hole 50, so that the engaging member 44 can have a return function. The button mechanism 34 is disposed on the device case 22 and connected to the protruding structure 26. The button mechanism 34 is used for driving the protruding structure 26 to move relative to the device case 22 when being pressed, so as to control the protruding structure 26 to be engaged with or separate from the guide rail structure 20. As for linkage design between the button mechanism 34 and the protruding structure 26, its related description is omitted herein since it is commonly seen in the prior art. Furthermore, please refer to FIG. 4, which is a bottom view of the electronic device 14 in FIG. 3. As shown in FIG. 4, the electronic device 14 further includes at least one pad 52 (four shown in FIG. 4) and has a fixing hole 54. The pad 52 is disposed on the device case 22 for providing friction force to the device case 22, so that the electronic device 14 can be disposed on a holding surface steadily. Furthermore, the electronic device 14 can also be screwed onto a support frame via the fixing hole 54.

Furthermore, as shown in FIG. 3, at least one containing slot 56 (two shown in FIG. 3) is formed on the device case 22 corresponding to the support foot 38 for containing the support foot 38 when the protruding structure 26 is engaged with the guide rail structure 20, so as to prevent the device case 22 and the projector case 16 from interfering with each other. In this embodiment, a long axis direction of the containing slot 56 is substantially parallel to an engaging direction (i.e. a +Y-axis direction as shown in FIG. 3) of the projector 12 and the electronic device 14. Furthermore, as shown in FIG. 2 and FIG. 3, an arc-shaped concave structure 58 is formed two sides of the device case 22 respectively, and a corresponding arc-shaped convex structure 60 is formed at two sides of the projector case 16 respectively, for guiding lateral sliding of the projector case 16 relative to the device case 22.

More detailed description for assembly and disassembly of the projector module 10 is provided as follows. Please refer to FIG. 1, FIG. 2, and FIG. 3. If a user wants to operate the projector 12, the user can utilize a cable to electrically connect the projector 12 to an external power source, such as a 110V power source in a common residence, for providing electrical power to drive the projector 12 to project images. If the projector 12 needs to be disposed at a specific height, the user can utilize the docking station 40 to install the projector 12 on a support frame. In such a manner, the user can utilize the support frame to adjust the installation height of the projector 12.

If the projector 12 needs to project images in an environment with no external power source (e.g. an outdoor environment), the user can utilize the electronic device 14 to provide electrical power to the projector 12 for increasing portability of the projector 12. The related assembly description is provided as follows. First, the bottom surface of the projector 12, which has the guide rail structure 20 formed thereon, needs to be aligned with the top surface of the electronic device 14, which has protruding structure 26 formed thereon. Before that, if there is the docking station 40 installed on the projector case 16, the docking station 40 needs to be detached from the projector case 16 first. Subsequently, via guidance of the arc-shaped concave structure 58 with the arc-shaped convex structure 60, the user can push the projector 12 laterally to slide toward the +Y-axis direction as shown in FIG. 3 relative to the electronic device 14 until the first connector 18 is electrically connected to the second connector 24. During this process, the four protruding structures 26 on the device case 22 can be engaged with the four guide rail structures 20 on the projector case 22 respectively with sliding of the projector 12, so as to constrain movement of the projector case toward ±X-axis directions, ±Y-axis directions, and ±Z-axis directions relative to the device case 22. Furthermore, the projector case 16 can also push the engaging member 44 of the locking mechanism 32 to retract back into the device case 22 (at this time, the spring 48 is compressed) until the first connector 18 is electrically connected to the second connector 24. At this time, since the engaging member 44 is aligned with the positioning hole 50 of the projector case 16 and is no longer pushed by the projector case 16, the elastic force provided by the spring 48 can drive the engaging member 44 to be engaged with the positioning hole 50 so as to constrain movement of the projector case 16 toward the −Y-axis direction relative to the device case 22.

In summary, via engagement of the protruding structure 26 and the guide rail structure 20 and engagement of the engaging member 44 and the positioning hole 50, the projector module 10 can has a three-axis positioning effect for installing the projector 12 on the electronic device 14 firmly (as shown in FIG. 1). Thus, the electronic device 14 can be utilized to provide electrical power to the projector 12 by electrical connection of the first connector 18 and the second connector 24, so that a user can still use the projector 12 to project images without an external power source in an outdoor environment. Furthermore, the electronic device 14 can be utilized as a holding base of the projector 12 since the geometric shape and size of the electronic device 14 are substantially equal to the geometric shape and size of the projector 12. In such a manner, via the said design that the projector 12 can be installed on the electronic device 14 integrally, the projector module 10 can have a compact look. After completing the said assembly process of the projector 12 and the electronic device 14, the projector module 10 can be further disposed on a support frame via the fixing hole 54 on the bottom surface of the electronic device 14 if the projector module 10 needs to be disposed at a specific height. Accordingly, the purpose that the installation height of the projector module 10 is adjustable can be achieved.

On the other hand, if the user wants to detach the projector 12 from the electronic device 14, the user just needs to push the operating member 46 downward to reject the engaging member 44 out of the positioning hole 50, so as to release movement constraint of the projector case 16 toward the −Y-axis direction relative to the device case 22. Subsequently, the user can pull the projector 12 laterally along the −Y-axis direction as shown in FIG. 1 to be separate from the electronic device 14, so as to complete the disassembly process of the projector 12 and the electronic device 14. Alternatively, the user can also press the button mechanism 34 to drive the protruding structure 26 to move toward the +Y-axis direction relative to the device case 22, so that movement constraints of the projector case 16 toward the ±X-axis directions, the ±Y-axis directions, and the ±Z-axis directions relative to the device case 22 can be released. Subsequently, the user can directly take the projector 12 from the electronic device 14 along the +Z-axis direction as shown in FIG. 1 instead of pulling the projector 12 laterally out of the electronic device 14. In such a manner, via the two different disassembly processes mentioned above, the disassembly operation of the projector module 10 can be more flexible.

It should be mentioned that the locking mechanism 32, the button mechanism 34, the arc-shaped concave structure 58, the arc-shaped convex structure 60, the support foot 38, the pads 36, 52, the plug 30, and the fixing hole 54 can be omissible for simplifying the structural design of the projector module 10. For example, the projector 12 can only utilize tight engagement of the guide rail structure 20 and the protruding structure 26 to be fixed onto the electronic device 14 without the locking mechanism 32. Furthermore, the containing slot 56 can also be omissible if there is no support foot 38 disposed on the projector case 16.

Furthermore, the assembly direction of the projector 12 and the electronic device 14 is not limited to the ±Y-axis directions. For example, the assembly direction of the projector 12 and the electronic device 14 can be changed accordingly (e.g. the ±X-axis directions as shown in FIG. 1) by properly modifying the configuration of the components of the projector 12 and the electronic device 14. Furthermore, the electronic device 14 is not limited to the power supply device. For example, the electronic device 14 can also be a DVD player, a speaker, or a hard disk drive, so that the electronic device 14 can perform video data transmission with the projector 12 instead when the second connector 24 is electrically connected to the first connector 18. As for which device type is utilized, it depends on the practical application of the projector module 10.

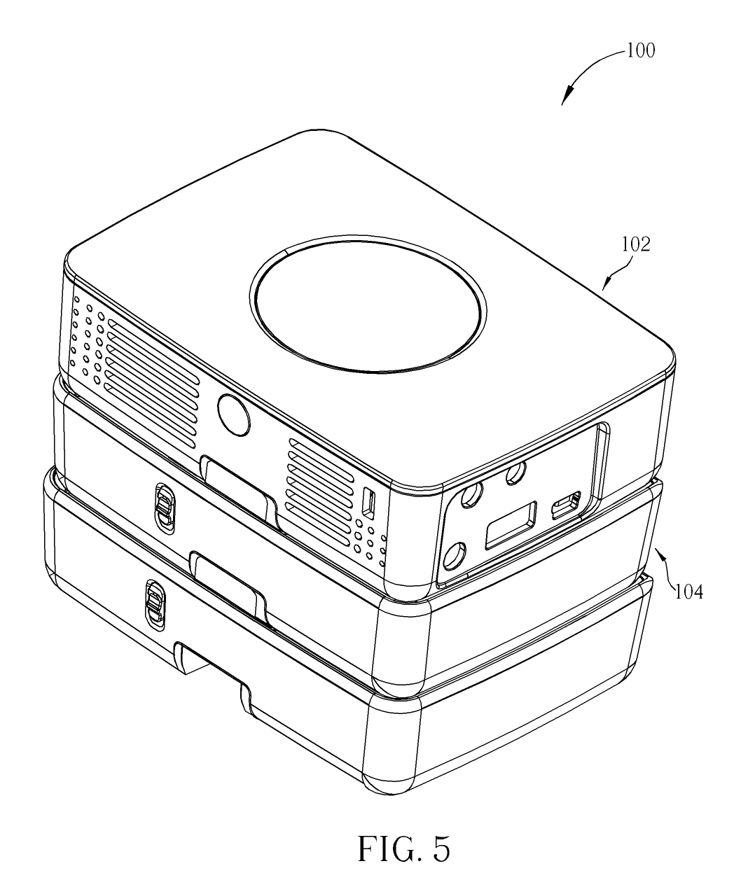

Please refer to FIG. 5, which is an assembly diagram of a combinative projector module 100 according to a second embodiment of the present invention. The major difference between the combinative projector module 100 and the projector module 10 is additional disposal of the guide rail structure and the design that the combinative projector module 100 is applied to assembly of a projector and a plurality of electronic devices. As shown in FIG. 5, the combinative projector module 100 includes a projector 102 and a plurality of electronic devices 104 (two shown in FIG. 5). The projector 102 can be detachably connected to the plurality of the electronic devices 104 respectively, and the electronic devices 104 can also be detachably combined with each other. In this embodiment, each electronic device 104 is preferably a battery, a DVD player, a speaker, or a hard disk drive, for performing power transmission or video data transmission with the projector 102. In the following, more detailed description for the structural designs of the projector 102 and one of the electronic devices 104 is provided. As for related description for the structural designs of the other electronic devices 104, it can be reasoned by analogy and therefore omitted herein.

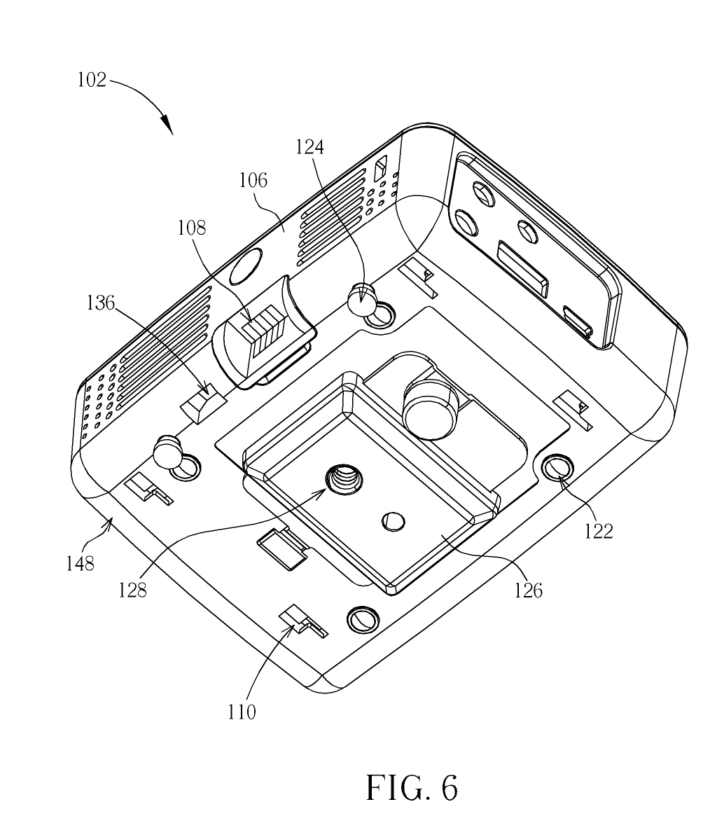

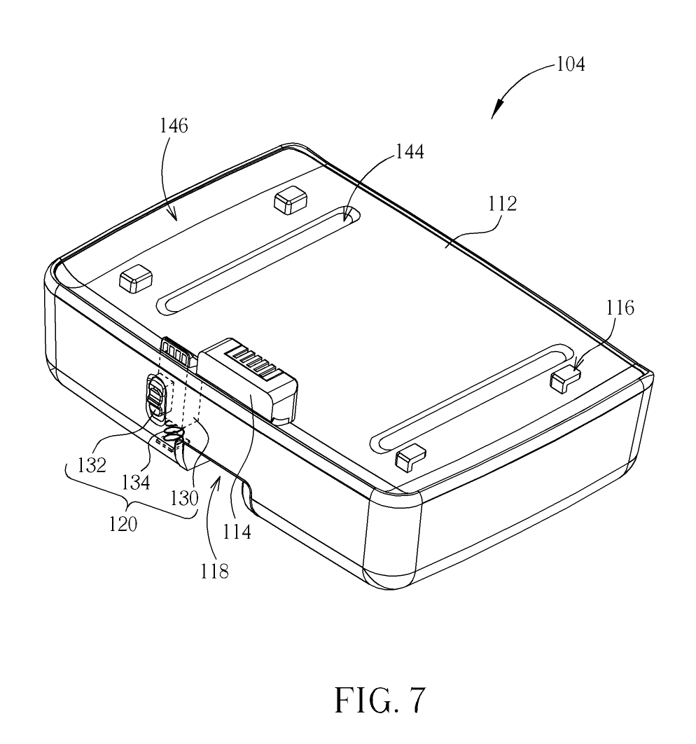

Please refer to FIG. 6 and FIG. 7. FIG. 6 is a diagram of the projector 102 in FIG. 5. FIG. 7 is a diagram of the electronic device 104 in FIG. 5. The projector 102 includes a projector case 106, a first connector 108, and at least one first guide rail structure 110 (four shown in FIG. 6). The electronic device 104 includes a device case 112, a second connector 114, at least one protruding structure 116 (four shown in FIG. 7), a third connector 118, and a locking mechanism 120.

First, the structural design of the projector 102 is described as follows. The first connector 108 is disposed on the projector case 106. The first connector 108 is used for electrically connecting to the second connector 114 to establish transmission between the projector 102 and the electronic device 104. The first guide rail structure 110 is disposed on the projector case 106. The first guide rail structure 110 is used for engaging with the protruding structure 116 so as to fix the projector 102 onto the electronic device 104 when the projector case 106 slides laterally relative to the device case 112 to make the second connector 114 electrically connected to the first connector 108.

Furthermore, the projector 102 further includes at least one pad 122 (four shown in FIG. 6), at least one support foot 124 (two shown in FIG. 6), and a docking station 126. The pad 122 is disposed on the projector case 106 for providing friction force to the projector case 106, so that the projector 102 can be disposed on a holding surface steadily. The support foot 124 is telescopically disposed on the projector case 106. The support foot 124 is used for adjusting an inclined angle of the projector case 106 so as to achieve the purpose that the projection angle of the projector 102 can be adjustable. The docking station 126 is detachably disposed on the projector case 106. When the docking station 126 is installed on the projector case 106, the projector case 106 can be screwed onto a support frame via a fixing hole 128 formed on the docking station 126.

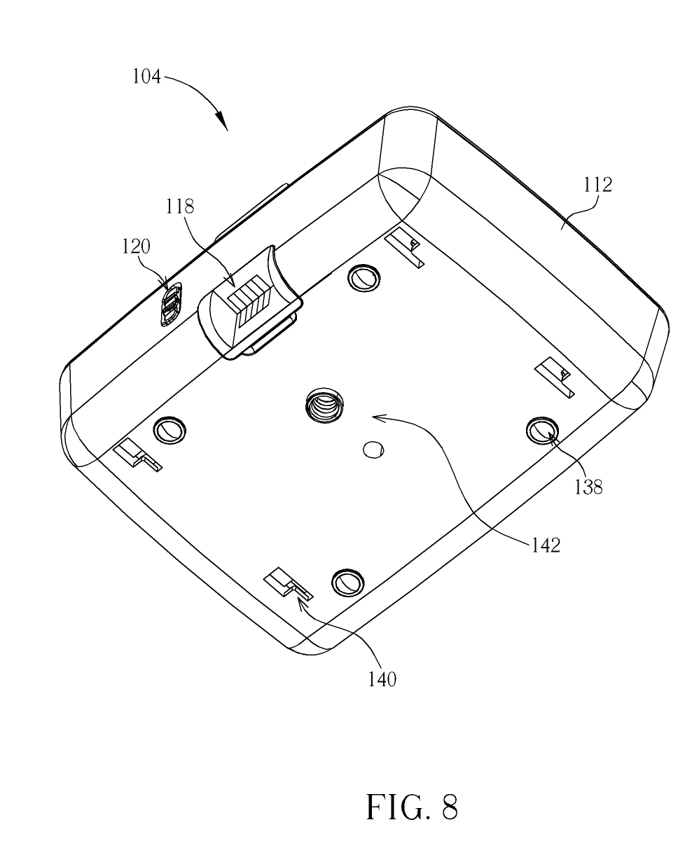

In the following, description for the structural design of the electronic device 104 is provided. The second connector 114, the protruding structure 116 and the third connector 118 are disposed on the device case 112. The third connector 118 is used for electrically connecting to the second connector 114 of other electronic device 104 to establish transmission between the electronic device 104 and the other electronic device 104. The locking mechanism 120 is disposed on the device case 112 for engaging with the projector case 106. The locking mechanism 120 includes an engaging member 130, an operating member 132, and a spring 134. The engaging member 130 is movably disposed on the device case 112 and is connected to the operating member 132. The operating member 132 is used for driving the engaging member 130 to make the engaging member 130 engaged with or separate from a positioning hole 136 of the projector case 106 as shown in FIG. 6. The spring 134 is connected to the engaging member 130 for providing elastic force to drive the engaging member 130 to be engaged with the positioning hole 136, so that the engaging member 130 can have a return function. Furthermore, please refer to FIG. 8, which is a bottom view of the electronic device 104 in FIG. 7. As shown in FIG. 8, the electronic device 104 further includes at least one pad 138 (four shown in FIG. 8) and at least one second guide rail structure 140 (four shown in FIG. 8) and has a fixing hole 142. The pad 138 is disposed on the device case 112 for providing friction force to the device case 112, so that the electronic device 104 can be disposed on a holding surface steadily. The second guide rail structure 140 is used for engaging with a protruding structure 116 of other electronic device 104 so as to fix a position of the electronic device 104 and the other electronic device 104.

Furthermore, as shown in FIG. 7, at least one containing slot 144 (two shown in FIG. 7) is formed on the device case 112 corresponding to the support foot 124 for containing the support foot 124 when the protruding structure 116 is engaged with the first guide rail structure 110 so as to prevent the device case 112 and the projector case 106 from interfering with each other. Furthermore, as shown in FIG. 6 and FIG. 7, an arc-shaped concave structure 146 is formed two sides of the device case 112 respectively, and a corresponding arc-shaped convex structure 148 is formed at two sides of the projector case 106 respectively, for guiding lateral sliding of the projector case 106 relative to the device case 112.

As for description for assembly and disassembly of the projector 102 and the plurality of electronic devices 104, it can be reasoned according to the said embodiment. In brief, via guidance of the arc-shaped convex structure 148 with the arc-shaped concave structure 146, engagement of the first guide rail structure 110 and the protruding structure 116, and engagement of the engaging member 130 and the positioning hole 136, the projector 102 can be disposed on the electronic device 104 firmly (as shown in FIG. 5). Similarly, the other electronic device 104 as shown in FIG. 5 can also utilize engagement of the second guide rail structure 140 and the protruding structure 116 to be disposed on the bottom side of the electronic device 104.

At this time, as shown in FIG. 5, the two electronic devices 104 in FIG. 5 can be utilized as a holding base of the projector 102 since the geometric shapes and sizes of the two electronic devices 104 are substantially equal to the geometric shape and size of the projector 102. In such a manner, via the said design that the projector 102 can be installed on the electronic devices 104 integrally, the combinative projector module 100 can have a compact look. To be noted, the projector 102 can establish video data transmission or power transmission with the two electronic devices 104. For example, the two electronic devices 104 in FIG. 5 can be a battery and a DVD player, respectively. In such a manner, the projector 102 in the combinative projector module 100 can directly obtain electrical power from the battery to project corresponding images according to video data transmitted from the DVD player without additionally connecting to an external power source. In another example, the two electronic devices 104 in FIG. 5 can be a DVD player and a speaker, respectively. In such a manner, the combinative projector module 100 can simultaneously project images and output corresponding sound without additionally connecting to other external video playback device. As for description for other derivative examples, it can be reasoned by analogy and therefore omitted herein.

On the other hand, the user can perform disassembly of the projector 102 and the two electronic devices 104 in FIG. 5 according to the disassembly steps mentioned in the first embodiment. To be noted, the linkage design for the button mechanism and the protruding structure can also be applied to the combinative projector module 100, so that the disassembly operation of the combinative projector module 100 can be more flexible.

The simplified designs mentioned in the first embodiment can also be applied to the combinative projector module 100 for simplifying the structural design of the combinative projector module 100. For example, the projector 102 can only utilize tight engagement of the first guide rail structure 110 and the protruding structure 116 to be fixed onto the electronic device 104 without the locking mechanism 120. Similarly, the electronic device 104 can only utilize tight engagement of the second guide rail structure 140 and the protruding structure 116 of other electronic device 104 to be fixed onto the other electronic device 104 without the locking mechanism 120. Furthermore, number of the electronic devices 104 is not limited to two as shown in FIG. 5, meaning that it can be increased according to the practical application of the combinative projector module 100. It should be mentioned that the first guide rail structure 110, the protruding structure 116, and the second guide rail structure 140 are omissible for further simplifying the structural design of the combinative projector module 100. That is to say, the combinative projector module 100 can only utilize connection of the connectors to assemble the electronic device 104 with the projector 102 or the other electronic device 104. As for which design is utilized, it depends on the practical application of the combinative projector module 100.

Compared with the prior art, in which a projector needs a cable to connect to an external electronic device, the present invention utilizes the guide rail structure and the connector directly disposed on the projector case to be connected to the protruding structure and the connector on the device case of the electronic device respectively. In such a manner, since the projector can directly establish power transmission or video data transmission with the electronic device without a cable, the present invention can enhance portability and use convenience of the projector greatly. Furthermore, via engagement of the guide rail structure and the protruding structure, the projector can also be detachably combined with at least one of the plurality of electronic devices, so as to improve scalability of the projector module of the present invention.

Those skilled in the art will readily observe that numerous modifications and alterations of the device and method may be made while retaining the teachings of the invention.

What is claimed is:

1. A projector module with an engagement design, the projector module comprising:
a projector comprising:
a projector case;
a first connector disposed on the projector case; and
at least one guide rail structure disposed on the projector case; and
an electronic device detachably disposed on the projector, the electronic device comprising:
a device case;
a second connector disposed on the device case for electrically connecting to the first connector so as to establish transmission between the projector and the electronic device; and
at least one protruding structure disposed on the device case for engaging with the guide rail structure so as to fix the projector onto the electronic device when the projector case slides laterally relative to the device case to make the first connector electrically connected to the second connector.

2. The projector module of claim 1, wherein the electronic device further comprises:
a battery disposed in the device case and electrically connected to the second connector for providing electrical power to the projector when the first connector is electrically connected to the second connector.

3. The projector module of claim 2, wherein the electronic device further comprises a plug disposed on the device case and electrically connected to the battery, and the plug is used to connect to an external power source for transmitting electrical power to the battery.

4. The projector module of claim 1, wherein the electronic device is a DVD (Digital Versatile Disk) player, a speaker, or a hard disk drive.

5. The projector module of claim 4, wherein the projector performs video data transmission with the electronic device when the first connector is electrically connected to the second connector.

6. The projector module of claim 1, wherein the electronic device further comprises:
a locking mechanism disposed on the device case for engaging with the projector case when the first connector is electrically connected to the second connector.

7. The projector module of claim 6, wherein the projector case has a positioning hole, and the locking mechanism comprises:
an engaging member movably disposed on the device case; and
an operating member connected to the engaging member for driving the engaging member to be engaged with or separate from the positioning hole.

8. The projector module of claim 7, wherein the locking mechanism further comprises:
a spring connected to the engaging member for providing elastic force to drive the engaging member to be engaged with the positioning hole.

9. The projector module of claim 1, wherein the electronic device further comprises:
at least one pad disposed on the device case.

10. The projector module of claim 1, wherein the projector further comprises:
at least one pad disposed on the projector case.

11. The projector module of claim 1, wherein the projector further comprises at least one support foot telescopically disposed on the projector case for adjusting an inclined angle of the projector case, and a containing slot is formed on the device case corresponding to the support foot for containing the support foot when the protruding structure is engaged with the guide rail structure.

12. The projector module of claim 11, wherein a long-axis direction of the containing slot is substantially parallel to an engagement direction of the projector and the electronic device.

13. The projector module of claim 1, wherein the electronic device further comprises:
a button mechanism disposed on the device case and connected to the protruding structure for driving the protruding structure to be engaged with or separate from the guide rail structure.

14. The projector module of claim 1, wherein the projector further comprises a docking station detachably disposed on the projector case, and the projector is screwed on the support frame via a fixing hole of the docking station.

15. The projector module of claim 1, wherein the electronic device is screwed on the support frame via a fixing hole of the device case.

16. The projector module of claim 1, wherein an arc-shaped concave structure is formed at least one side of the device case, and an arc-shaped convex structure is correspondingly formed at least one side of the projector case for guiding lateral sliding of the projector case relative to the device case.

17. The projector module of claim 1, wherein the geometric shape and size of the electronic device are substantially equal to the geometric shape and size of the projector.

18. A combinative projector module comprising:
a projector comprising:
a projector case; and
a first connector disposed on the projector case; and
a plurality of electronic devices detachably disposed on the projector, each electronic device comprises:
a device case;
a second connector disposed on the device case for electrically connecting to the first connector to establish transmission between the projector and the electronic device; and
a third connector disposed on the device case for electrically connected to the second connector on another electronic device to establish transmission between the two electronic devices.

19. The combinative projector module of claim 18, wherein the projector further comprises at least one first guide rail structure disposed on the projector case, each electronic device further comprises at least one protruding structure and at least one second guide rail structure, the protruding structure is disposed on the device case for engaging with the first guide rail structure so as to fix the projector onto the electronic device when the projector case slides laterally relative to the device case to make the first connector electrically connected to the second connector, and the second guide rail structure is disposed on the device case for engaging with the protruding structure of another electronic device so that the electronic devices can be detachably combined with each other.

20. The combinative projector module of claim 19, wherein the projector further comprises at least one support foot telescopically disposed on the projector case for adjusting an inclined angle of the projector case, and a containing slot is formed on the device case corresponding to the support foot for containing the support foot when the protruding structure is engaged with the first guide rail structure.

21. The combinative projector module of claim 20, wherein a long-axis direction of the containing slot is substantially parallel to an engagement direction of the projector and the plurality of electronic devices.

22. The combinative projector module of claim 18, wherein each electronic device is a battery device, a DVD player, a speaker, or a hard disk drive.

23. The combinative projector module of claim 18, wherein each electronic device further comprises:
a locking mechanism disposed on the device case for engaging with the projector case when the first connector is electrically connected to the second connector.

24. The combinative projector module of claim 23, wherein the projector case has a positioning hole, and the locking mechanism comprises:
an engaging member movably disposed on the device case; and
an operating member connected to the engaging member for driving the engaging member to be engaged with or separate from the positioning hole.

25. The combinative projector module of claim 24, wherein the locking mechanism further comprises:
a spring connected to the engaging member for providing elastic force to drive the engaging member to be engaged with the positioning hole.

26. The combinative projector module of claim 18, wherein the electronic device further comprises:
at least one pad disposed on the device case.

27. The combinative projector module of claim 18, wherein the projector further comprises at least one pad disposed on the projector case.

28. The combinative projector module of claim 18, wherein the projector further comprises a docking station detachably disposed on the projector case, and the projector is screwed on the support frame via a fixing hole of the docking station.

29. The combinative projector module of claim 18, wherein the electronic device is screwed on the support frame via a fixing hole of the device case.

30. The combinative projector module of claim 18, wherein an arc-shaped concave structure is formed at least one side of the device case, and an arc-shaped convex structure is correspondingly formed at least one side of the projector case for guiding lateral sliding of the projector case relative to the device case.

31. The combinative projector module of claim 18, wherein the geometric shape and size of the electronic device are substantially equal to the geometric shape and size of the projector.
